(19) United States
(12) Patent Application Publication
(10) Pub. No.: US 2018/0174568 A1
(43) Pub. Date: Jun. 21, 2018

(54) STRUCTURE ESTABLISHING A SOUND INSULATOR

(71) Applicant: Airbus Operations SAS, Toulouse (FR)

(72) Inventors: Alain PORTE, COLOMIERS (FR); Jean-Michel ROGERO, TOULOUSE (FR); Arnulfo CARAZO MENDEZ, TOULOUSE (FR)

(21) Appl. No.: 15/841,514

(22) Filed: Dec. 14, 2017

(30) Foreign Application Priority Data
Dec. 20, 2016 (FR) 1662821

(51) Int. Cl. G10K 11/168; B64D 33/02

(52) U.S. Cl. CPC G10K 11/168; B64D 2033/0206; B64D 33/02

(57) ABSTRACT

A structure establishing a sound insulator and including a first plate, a second plate having holes therethrough, and a web stuck between the plates. The web includes a plurality of intermediate strips perpendicular at least to one of the plates, a plurality of folded strips which are folded in a zig-zag formation, each folded strip being arranged between two successive intermediate strips, and establishes, with the intermediate strips, triangular prisms, where, for two folded strips on either side of a same intermediate strip, the generator of the triangular prism of one of the folded strips forms an acute angle with respect to the first plate, and the generator of the triangular prism of the other folded strip forms an obtuse angle with respect to the first plate.

### CROSS-REFERENCES TO RELATED APPLICATIONS

This application claims the benefit of the French patent application No. 1662821 filed on Dec. 20, 2016, the entire disclosures of which are incorporated herein by way of reference.

### TECHNICAL FIELD

The present invention relates to a structure establishing a sound insulator, a method for manufacturing such a structure, and a machine used in the context of said manufacturing method.

### BACKGROUND OF THE INVENTION

When operating, an aircraft engine generates noise. The engine is housed in a nacelle and to reduce this noise, it is known to install structures establishing a sound insulator around the engine in the structure of the nacelle.

Such structures establishing a sound insulator have, for example, the form of honeycomb structures. Such a honeycomb structure includes two parallel plates, one of which is perforated, and between which hexagonal cells placed side-by-side are arranged.

To increase the effectiveness of the low frequency sound treatments of the honeycomb structure, it is known to incline each rectangular cell with respect to the normal to the plates. Such a honeycomb inclined structure is described in the document U.S. Pat. No. 3,821,999.

Although, from a sound point of view, such a honeycomb inclined structure provides good results, the structural behavior, in particular during compression, of such a structure is reduced with respect to the structural behavior of a structure having cells that are not inclined. Moreover, since such a honeycomb inclined structure is produced by cutting a honeycomb non-inclined structure, this results in large material losses during the manufacture thereof.

### SUMMARY OF THE INVENTION

An object of the present invention is to propose a structure establishing a sound insulator which, in particular, makes it possible to obtain a more mechanically robust structure.

To this end, a structure establishing a sound insulator is proposed which includes:
a first plate,
a second plate having holes therethrough,
a web stuck between the first plate and the second plate, said web including:
a plurality of intermediate strips perpendicular at least to one plate from the first plate and from the second plate and extending between the two plates,
a plurality of folded strips which are folded in a zig-zag formation,

each folded strip is arranged between two successive intermediate strips, where every other crease line is stuck to one of the two intermediate strips and the other crease lines are stuck to the other of the two intermediate strips, where the two folds of the folded strip which are on either side of a crease line establish two faces of a triangular prism and the zone of the intermediate strip which is stuck to the two crease lines adjacent to the crease line which is between said two folds establishes the third face of the triangular prism,

where, for two folded strips on either side of a same intermediate strip, the generator of the triangular prism of one of the folded strips forms an acute angle with respect to the first plate, and the generator of the triangular prism of the other folded strip forms an obtuse angle with respect to the first plate.

The triangular structure with two reverse inclines makes it possible to obtain a structure establishing an effective sound insulator and having a reinforced mechanical structure, and to limit the losses during the manufacture thereof.

Advantageously, the intermediate strips undergo a first folding and a stacked second folding, and the two foldings take place with different folding angles.

Advantageously, the folding line corresponding to the first folding and the folding line corresponding to the second folding intersect at a point located on an edge of the intermediate strip.

The invention also proposes a method for manufacturing a structure establishing a sound insulator, the manufacturing method including:
a method for folding strips in order to obtain folded strips using a folding machine including:
two rollers, each roller being rotatably mounted about the axis thereof, and the two axes being parallel with a midplane in which the strip falls, and
a first and a second plate, each plate, having a leading edge, being translatable, firstly, in first directions in a plane perpendicular to the midplane, and, secondly, in second directions parallel with the midplane, the leading edges of the plates being parallel with each other and not being parallel with the midplane, the strip being guided between the two rollers toward the plates,
a step for sticking intermediate strips and folded strips between plates, by inserting a folded strip between two intermediate strips, and by positioning them such as to produce reverse incline generators,

the folding method including, when the first plate is between a fold and the rollers:
a step in which the leading edge of the second plate attacks the strip in order to fold it the other way, the second plate being located between the first plate and the rollers,
a step in which the first plate is withdrawn,
a step in which the second plate is moved such as to crush the folds already produced,
a step in which the first plate is moved such as to pass between the second plate and the rollers,
a step in which the leading edge of the first plate attacks the strip on the first side in order to fold it,
a step in which the second plate is withdrawn,
a step in which the first plate is moved such as to crush the folds already produced,
a step in which the second plate is moved such as to pass between the first plate and the rollers,
a step in which the leading edge of the second plate attacks the strip on the second side, and so on.

The invention also proposes a folding machine including:
two rollers, each roller being motorized and rotatably mounted about the axis thereof, and the two axes being parallel with a midplane,
a first and a second plate, each plate, having a leading edge, being translatable, firstly, in first directions in a plane perpendicular to the midplane, and, secondly, in second directions parallel with the midplane, the leading edges of the plates being parallel with one another and not being parallel with the midplane,
actuators making it possible to move each plate in each of the directions, and
a control unit which commands each actuator in order to provide the appropriate movements of each plate and roller.

Advantageously, each plate is rotatable about an axis normal to the surface thereof, and the folding machine comprises, for each plate, an actuator commanded by the control unit in order to rotate said plate.

### BRIEF DESCRIPTION OF THE DRAWINGS

The features of the invention which are mentioned above, as well as others, will emerge more clearly upon reading the following description of an exemplary embodiment, said description being given with reference to the appended drawings, wherein:

FIG. 1 is a perspective view of the structure establishing a sound insulator according to the invention,

FIGS. 2A-2D show steps for manufacturing a folded strip of the structure establishing a sound insulator of FIG. 1,

FIG. 3 shows a top view of a machine used in the context of manufacturing the structure establishing a sound insulator,

FIGS. 4A-4C show steps for manufacturing an intermediate strip of the structure establishing a sound insulator,

FIG. 5A shows a side view of a folded intermediate strip, and

FIG. 5B shows a top view of the intermediate strip of FIG. 5A.

### DETAILED DESCRIPTION OF THE PREFERRED EMBODIMENTS

FIG. 1 shows a structure 100 establishing a sound insulator and having the form of a honeycomb structure. The structure 100 comprises a first plate 102 and a second plate 104 which are distanced from one another. One of the plates, in this case the second plate 104, has holes 106 therethrough to allow the passage of sound waves.

A web 108 is placed between the first plate 102 and the second plate 104, which web is stuck to the first plate 102 and to the second plate 104.

The web is established from a plurality of intermediate strips 110 and from a plurality of folded strips 112a and 112b.

The intermediate strips 110 are perpendicular at least to one plate from the first plate 102 and from the second plate 104 and extend between the two plates 102 and 104. Each intermediate strip 110 is stuck via one of the sidewalls thereof to the first plate 102 and by the other sidewall thereof to the second plate 104.

In the invention embodiment shown in FIG. 1, the intermediate strips 110 are parallel with one another, but in other embodiments, they might not be.

Each folded strip 112a-b is arranged between two successive intermediate strips 110 and each folded strip 112a, 112b is folded in a zig-zag formation. Each folded strip 112a-b is stuck to the first plate 102 and to the second plate 104. The manner in which the strips and plates are stuck to each other may depend on the materials from which the strips and plates are made, in that, with thermoplastic materials, a pressing engagement between the strips and plates at an elevated temperature would cause the strips and plates to be stuck or bound together. With other materials, an adhesive could be used to cause the strips and plates to be stuck or bound together.

Each folded strip 112a-b is, thus, a series of crease lines 114 and of folds 116.

For a folded strip 112a-b, every other crease line 114 is stuck to one of the intermediate strips 110 and the other crease lines 114 are stuck to the other intermediate strip 110.

The two folds 116 of the folded strip 112a-b which are on either side of a crease line 114 form two faces of a triangular prism and the zone of the intermediate strip 110 which is stuck to the two crease lines 114 adjacent to the crease line 114 which is between said two folds 116 establishes the third face of the triangular prism. In a section parallel with the two plates 102 and 104, the folds 116 of the folded strip 112a-b and the intermediate strips 110 form triangles.

The web 108 thus forms an isogrid shape.

For each folded strip 112a, 112b, the generator of the triangular prism is not perpendicular to the plates 102 and 104, and each folded strip 112a, 112b and the intermediate strips 110 thus create an oblique triangular prism.

Sticking the triangular prisms to each plate 102, 104 seals each triangular prism.

For two adjacent folded strips 112a-b, i.e., on either side of a same intermediate strip 110, the generator of the triangular prism of one of the folded strips 112a has, seen from a direction perpendicular to the intermediate strips 110, an acute angle α with respect to the first plate 102, and the generator of the triangular prism of the other folded strip 112b has, seen from the same perpendicular direction, an obtuse angle β with respect to the first plate 102. In other words, for two adjacent folded strips 112a-b seen from a same direction perpendicular to the intermediate strips 110, one is tilted one way and the other is tilted the other way with respect to the direction normal to the first plate 102.

This double incline structure makes it possible to have an increased mechanical strength. In particular, it has a better mechanical strength during compression.

The first plate 102 and the second plate 104 are produced, for example, from carbon fiber, from metal materials of titanium or aluminum alloy type, or also from thermoplastic composites of PEI (polyetherimide), PEAK (polyaryletherketone) or PEEK (polyether ether ketone) type.

The intermediate strips 110 and the folded strips 112a and 112b are produced, for example, from paper, of aramid paper type, from metal materials of titanium or aluminum alloy type, but also from thermoplastic composites of PEI (polyetherimide), PEAK (polyaryletherketone) or PEEK (polyether ether ketone) type.

According to a particular embodiment, the angle α of inclination of a folded strip 112a is between 10° and 80°, preferably between 40° and 60° and, the angle β of inclination of the adjacent folded strip 112b is between 100° and 170°, preferably between 120° and 140°.

When the plates 102 and 104 are not planar but curved, for example to follow the curvature of the nacelle of an engine, the intermediate strips 110 must follow this curvature. For this purpose, each intermediate strip 110 is folded as is explained hereafter such that the folded zone is flattened, i.e., in the plane of the intermediate strip 110.

FIG. 5A and FIG. 5B show an intermediate strip 110 having undergone folding. In the invention embodiment shown in FIGS. 5A and 5B, the intermediate strip 110 has undergone a first folding making it possible to turn over the intermediate fold 502b onto the upstream fold 502a of the intermediate strip 110, then a second folding making it possible to turn over the downstream fold 502c onto the intermediate fold 502b. In this case, the first folding perpendicular to the longitudinal direction of the upstream fold 502a, and the second folding are carried out with a different angle such as to offset the downstream fold 502c with respect to the upstream fold 502a such as to give a curvature to the intermediate strip 110.

In an advantageous embodiment, the folding line corresponding to the first folding and the folding line corresponding to the second folding intersect at a point located on an edge of the intermediate strip 110.

Of course, the folding angles can be changed according to the curvature to be obtained, and generally, each intermediate strip 110 undergoes a first folding and a second folding stacked on the first folding, the two foldings taking place with different folding angles.

The operation for folding the intermediate strip 110 can be repeated according to the geometry to be obtained.

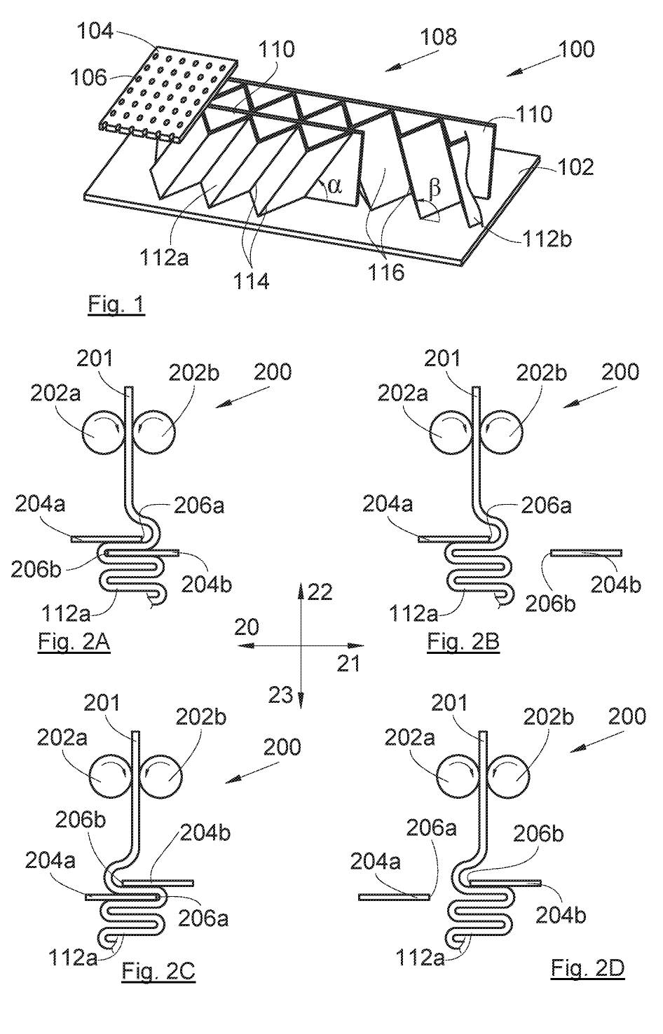

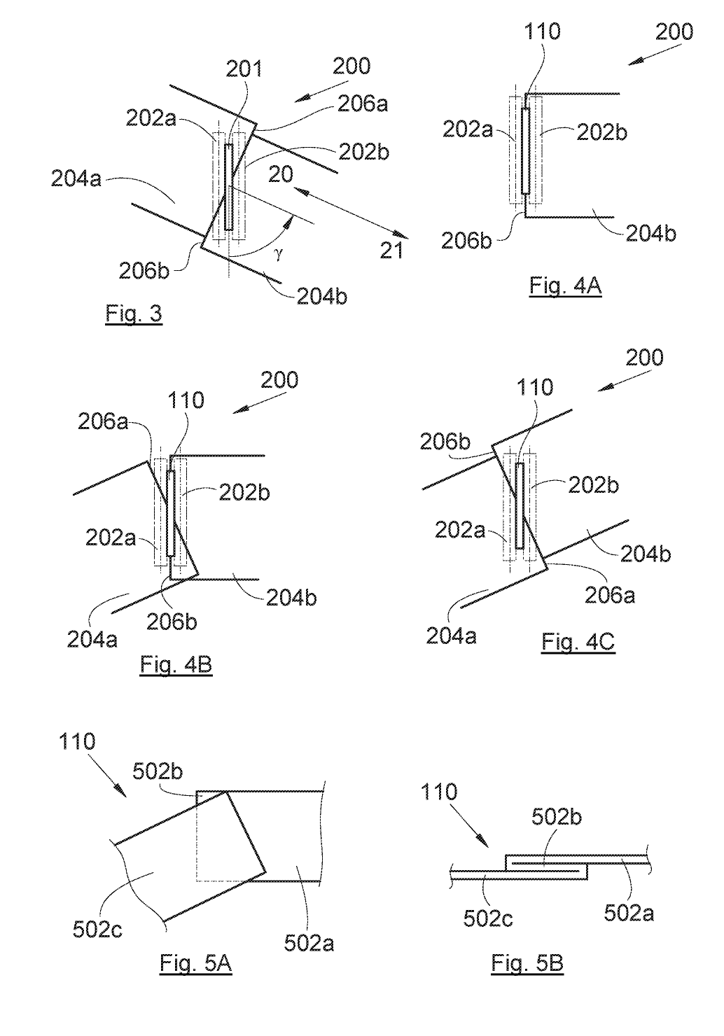

FIGS. 2A-2D show side views of a folding machine 200 for folding the folded strips 112a-b, and FIG. 3 shows a top view of the folding machine 200.

The folding machine 200 comprises two rollers 202a-b and two plates 204a-b.

Each roller 202a-b is rotatably mounted about the axis thereof, and the two axes are parallel. The two rollers 202a-b are used to supply the folding machine 200 with strip 201 and are motorized in order to drive and guide the strip 201 which is placed therebetween toward the plates 204a-b.

After folding, the strip 201 will become a folded strip 112a-b.

The axes of the two rollers 202a-b are parallel with the midplane in which the strip 201 falls, i.e., the plane equidistant from the two axes.

Each plate 204a-b has a leading edge 206a-b which attacks the strip 201 in order to fold it.

Each plate 204a-b is translatable, firstly, in a plane perpendicular (first directions 20 and 21) to the midplane, and, secondly, parallel (second directions 22 and 23) with the midplane, i.e., with the strip 201 coming from the rollers 202a-b.

To this end, the folding machine 200 has actuators for moving each plate 204a-b in each of the directions. Each actuator is motorized and comprises, for example, for each direction, slides translating each plate 204a-b, and an activator such as a motor, a jack, etc., for moving the plates 204a-b along the slides one way or the other way.

The folding machine 200 also includes a control unit, such as a processor, which commands each actuator in order to provide the appropriate movements of each plate 204a-b as are described hereafter.

The control unit also controls the actuator of each roller 202a-b in order to rotate it.

FIG. 3 shows a top view of the folding machine 200. As is shown in FIG. 3, the leading edges of the plates 204a-b are parallel with one another and are not parallel with the midplane of the strip 201 when it is between the rollers 202a-b. The angle γ between the midplane and the first directions 20 and 21 determines the angle of inclination (α, β) of the folded strip 112a-b.

A folding method for obtaining a folded strip 112a-b, which method is implemented by the folding machine 200, is explained hereafter, taking into consideration that at least one folding has already been carried out (FIG. 2A), the strip 201 being transported between the rollers 202a-b up to the plates 204a-b. This folding method then includes, when the first plate 204b is between a fold and the rollers 202a-b:
a step in which the leading edge 206b of the first plate 204b has attacked (20) the strip 201 on a first side in order to fold it and hold it in position, the first plate 204b therefore being between a fold and the rollers 202a-b,
a step in which the leading edge 206a of the first plate 204a attacks (21, FIG. 2A) the strip 201 on a second side in order to fold it the other way, the second plate 204a being located between the first plate 204b and the rollers 202a-b, the first plate 204b remaining in position in order to hold the strip 201 that has already been folded,
a step in which the first plate 204b is withdrawn (21, FIG. 2B),
a step in which the second plate 204a is moved (23) in order to crush the folds already produced,
a step in which the first plate 204b is moved (22) such as to pass between the second plate 204a and the rollers 202a-b,
a step in which the leading edge 206b of the first plate 204b attacks (20) the strip 201 on the first side in order to fold it,
a step in which the second plate 204a is withdrawn (20, FIG. 2D),
a step in which the first plate 204b is moved (23) such as to crush the folds already produced,
a step in which the second plate 204a is moved (22) such as to pass between the first plate 204b and the rollers 202a-b, the first plate 204b remaining in position in order to hold the strip 201 which has already been folded,
a step in which the leading edge 206a of the second plate 204a attacks (21, FIG. 2A) the strip 201 on the second side, and so on.

When the folding of the strip has ended, the folded strip 112a-b is obtained.

A method for manufacturing the structure 100 comprises producing folded strips 112a-b according to the folding method described above, then in carrying out a step for sticking intermediate strips 110 and folded strips 112a-b between the plates 102 and 104, by inserting a folded strip 112a-b between two intermediate strips 110, and positioning them such as to produce reverse incline generators.

FIGS. 4A-C show top views of the same folding machine 200 allowing the folding of an intermediate strip 110 when it must be curved as is shown in FIG. 5.

In this case, each plate 204a-b is also a rotatable about an axis normal to the surface thereof, and for this purpose, the folding machine 200 comprises, for each plate 204a-b, an actuator, such as a motor, commanded by the control unit to rotate said plate.

A folding method for obtaining a folded intermediate strip 110, which method is implemented by the folding machine 200, is explained hereafter, the intermediate strip 110 being transported between the rollers 202a-b up to the plates 204a-b:
the leading edge 206b of the first plate 204b attacks the intermediate strip 110 on a first side in order to fold it and, in the embodiment shown in this case, the first plate 204b moves perpendicular to the midplane (FIG. 4A),
the second plate 204a is rotated about the axis normal to the surface thereof such that the leading edge 206a thereof forms an angle different to 90° with the midplane,
the second plate 204a attacks (FIG. 4B) the intermediate strip 110 on a second side in order to fold it the other way in order to turn over the intermediate fold 502b onto the upstream fold 502a, the second plate 204a being located between the first plate 204b and the rollers 202a-b, the first plate 204b remaining in position in order to hold the already folded strip 201,
the first plate 204b is withdrawn (FIG. 2B),
the first plate 204b is rotated about the axis normal to the surface thereof such that the leading edge 206b thereof is parallel with the leading edge of the second plate 204a,
the first plate 204b is moved such as to pass between the second plate 204a and the rollers 202a-b,
the leading edge 206b of the first plate 204b attacks the intermediate strip 110 on the first side in order to fold it so as to turn over the downstream fold 502c onto the intermediate fold 502b.

When the folding of the strip has ended, the folded intermediate strip 110 is obtained.

Of course, depending on the shape to be obtained for the intermediate strip, the angles of the plates 204a-b with respect to the midplane can be different.

The aforementioned manufacturing method makes it possible to manufacture the structure 100 while minimizing material losses.

The folded strips 112a-b can be produced from a thermosetting composite, for example of epoxy resin type, and the folds are then produced by compression in a mold in an autoclave, or by forging in a dedicated mold outside an autoclave. These two methods are carried out at temperatures and pressures that are normal for thermosetting resins, namely 2 to 7 bar and 180° C. in an autoclave, or 10 to 50 bar and 180° C. in the case of forging.

It is also possible to produce the intermediate strips 110 and/or the folded strips 112a-b by additive material 3D printing (ALM: Additive Layer Manufacturing), in particular in the cases of using metal materials or composites.

In a specific embodiment, notches are cut at ends of the folded strips 112a-b in contact with the plate 102 and/or the plate 104 and at ends of the intermediate strips 110 in contact with the plate 102 and/or the plate 104. These notches allow drainage of liquid which could build up in the structure 100. According to a first alternative, these notches are cut after sticking the folded strips 112a-b onto the intermediate strips 110 and before sticking the plates 102 and/or 104. In a second alternative, these notches are cut before folding the folded strips 112a-b.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A structure establishing a sound insulator and including:
a first plate,
a second plate having holes therethrough,
a web stuck between the first plate and the second plate, said web including:
a plurality of intermediate strips perpendicular at least to one plate from the first plate and from the second plate and extending between the two plates,
a plurality of folded strips which are folded in a zig-zag formation,
each folded strip is arranged between two successive intermediate strips, where every other crease line is stuck to one of the two intermediate strips and the other crease lines are stuck to the other of the two intermediate strips, where the two folds of the folded strip which are on either side of a crease line establish two faces of a triangular prism and the zone of the intermediate strips which is stuck to the two crease lines adjacent to the crease line which is between said two folds establishes the third face of the triangular prism,
where, for two folded strips on either side of a same intermediate strip, the generator of the triangular prism of one of the folded strips forms an acute angle with respect to the first plate, and the generator of the triangular prism of the other folded strip forms an obtuse angle with respect to the first plate.

2. The structure according to claim 1, wherein the intermediate strips undergo a first folding and a stacked second folding, and wherein the two foldings take place with different folding angles.

3. The structure according to claim 2, wherein the folding line corresponding to the first folding and the folding line corresponding to the second folding intersect at a point located on an edge of the intermediate strip.

4. A method for manufacturing a structure according to claim 1, the manufacturing method including:
a method for folding strips in order to obtain folded strips using a folding machine including:
two rollers, each roller being rotatably mounted about the axis thereof, and the two axes being parallel with a midplane in which the strip falls, and
a first and a second plate, each plate, having a leading edge, being translatable, firstly, in first directions in a plane perpendicular to the midplane, and, secondly, in second directions parallel with the midplane, the leading edges of the plates being parallel with each other and not being parallel with the midplane, the strip being guided between the two rollers toward the plates,
the steps of the method for manufacturing comprising:
sticking intermediate strips and folded strips between plates, by inserting a folded strip between two intermediate strips, and by positioning the folded strips to produce reverse incline generators,
the folding method comprising, when the first plate is between a fold and the rollers:
attacking the strip on a second side with the leading edge of the second plate to fold the strip oppositely, the second plate being located between the first plate and the rollers,
withdrawing the first plate from the strip,
moving the second plate to crush the folds already produced,
moving the first plate to pass between the second plate and the rollers,
attacking the strip on a first side with the leading edge of the first plate on the first side in order to fold the strip,
withdrawing the second plate,
moving the first plate to crush the folds already produced,
moving the second plate to pass between the first plate and the rollers,
repeating the above steps of the folding method.

5. A folding machine comprising:
two rollers, each roller being motorized and rotatably mounted about the axis thereof, and the two axes being parallel with a midplane,
a first and a second plate, each plate, having a leading edge, being translatable, firstly, in first directions in a plane perpendicular to the midplane, and, secondly, in second directions parallel with the midplane, the leading edges of the plates being parallel with one another and not being parallel with the midplane,
actuators configured to move each plate in each of the directions, and
a control unit configured to command each actuator to provide the appropriate movements of each plate and roller.

6. The folding machine according to claim 5, wherein each plate is rotatable about an axis normal to the surface thereof, and wherein the folding machine comprises, for each plate, an actuator commanded by the control unit to rotate said plate.
